(19) United States
(12) Patent Application Publication
(10) Pub. No.: US 2001/0041235 A1
(43) Pub. Date: Nov. 15, 2001

(54) Casing with provision for closing an opening therein

(76) Inventors: Dilip K. Tailor, Brampton (CA); Jeffrey A.D. State, Etobicoke (CA); Amarjit Tathgur, Brampton (CA)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/791,920

(22) Filed: Feb. 22, 2001

Related U.S. Application Data
(63) Continuation of application No. PCT/CA00/00787, filed on Jun. 30, 2000.

(30) Foreign Application Priority Data
Jun. 30, 1999 (CA) 2,276,708

(51) Int. Cl. B32B 1/08

(52) U.S. Cl. 428/36.1

(57) ABSTRACT

A casing member (11) for forming a connection between tubular sections, having at least end portions that are heat shrinkable. The member (11) has a patch member (12, 16) bonded to a surface of a portion of the member (11). The patch member (12, 16) may be bonded to a continuous imperforate portion of the member (11), or an opening (22) may be formed through the patch member (12, 16) and through the adjacent portion of the member. The patch member facilitates application of a plug (23) for closing the opening (22).

This application is continuation of and claims priority under 35 U.S.C. §120 from PCT Application Ser. No. PCT/EP00/04784, filed May 25, 2000, and U.S. application Ser. No. 09/311,145 filed May 13, 1999.

The present invention relates to at least partially heat shrinkable members for forming a connection between tubular sections. Such members may, for example, be used in the formation of casings for preinsulated pipe joints. Usually, an opening is made in such casing through which a liquid precursor of a foam composition may be poured. After the foam composition is allowed to foam and cure, the opening is closed with a plug.

Known casings formed of which the applicant is aware have presented problems of forming a closure between the casing and the plug.

Published PCT application WO 98/21517 dated May 22, 1998 in the name of the present applicant discloses various forms of casing that provide a relatively uncrosslinked layer to which a plug may be fused. In one form, there is disclosed an inner relatively uncrosslinked tube fused to an outer cross linked tube. The provision of such inner tube is not always convenient, however.

In the present invention there is provided a casing member for forming a connection between tubular sections, at least end portions of the member being heat-shrinkable, and the casing member having bonded to a surface of a continuous imperforate portion thereof a patch member through which an opening may be formed and a plug applied to close the opening.

In one example, such patches provide an uncrosslinked or relatively uncrosslinked layer (as compared to the material of the casing) to which a foam hole plug may be fused. In use, an aperture may be formed through the casing wall and through the patch, and the plug fused to such hole after the foam filling. In such case, the plug may be relatively conveniently fusion bonded to the edge of the opening in the patch member.

For determination of a degree of crosslinking the preferred method is by gel fraction in the conventional manner.

In a further form, the patch may provide a side, for example an outer side which is planar or has a larger radius of curvature than the casing, to facilitate attachment of plugs, for example mechanically attached plugs, to an opening formed through the patch and through the casing wall.

Further, the patch may provide an increased wall thickness to facilitate fusion of a plug or mechanical attachment or locking of a mechanically attached plug to an opening formed through the patch and through the casing wall.

Some examples of casings in accordance with the present invention will now be described in more detail, by way of example only, with reference to the accompanying drawing.

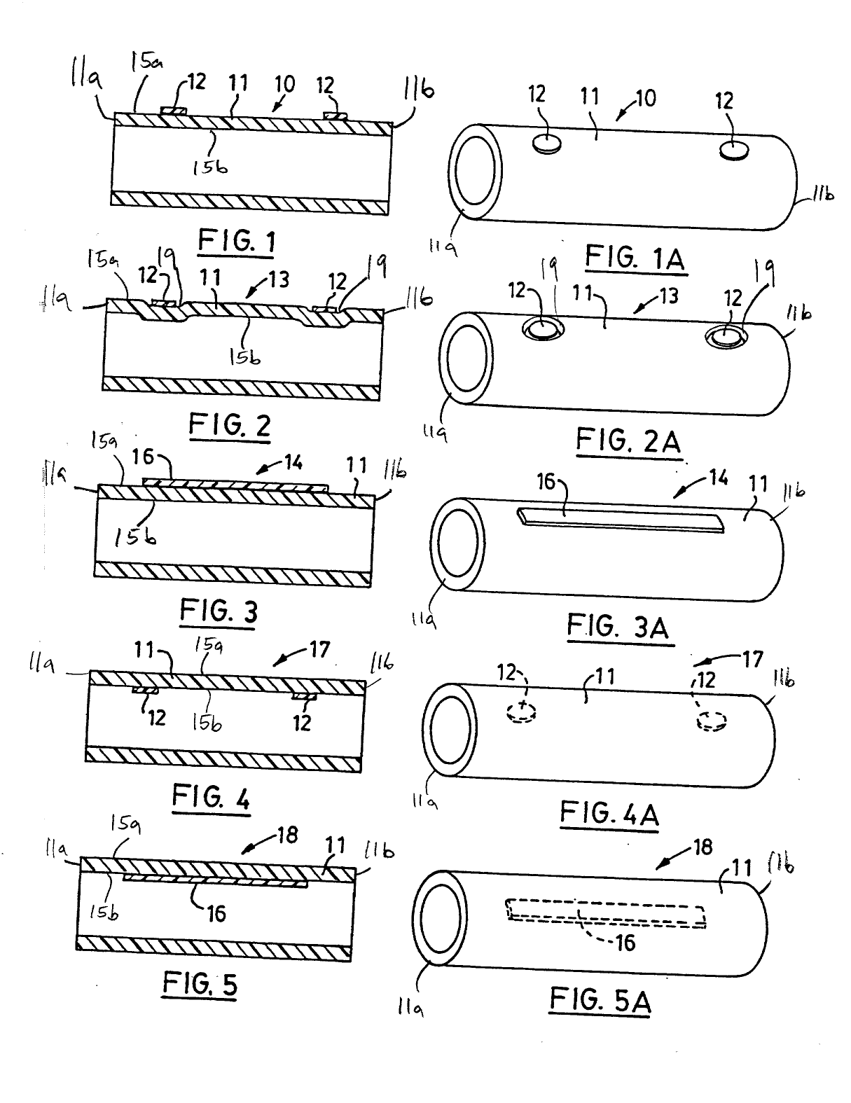

FIGS. 1, 2, 3, 4 and 5 show axial cross-sections through five different embodiments of tubular casing members provided with patch members in accordance with the invention.

FIGS. 1A, 2A, 3A, 4A and 5A show somewhat schematically isometric views of the casings of FIGS. 1 to 5, respectively.

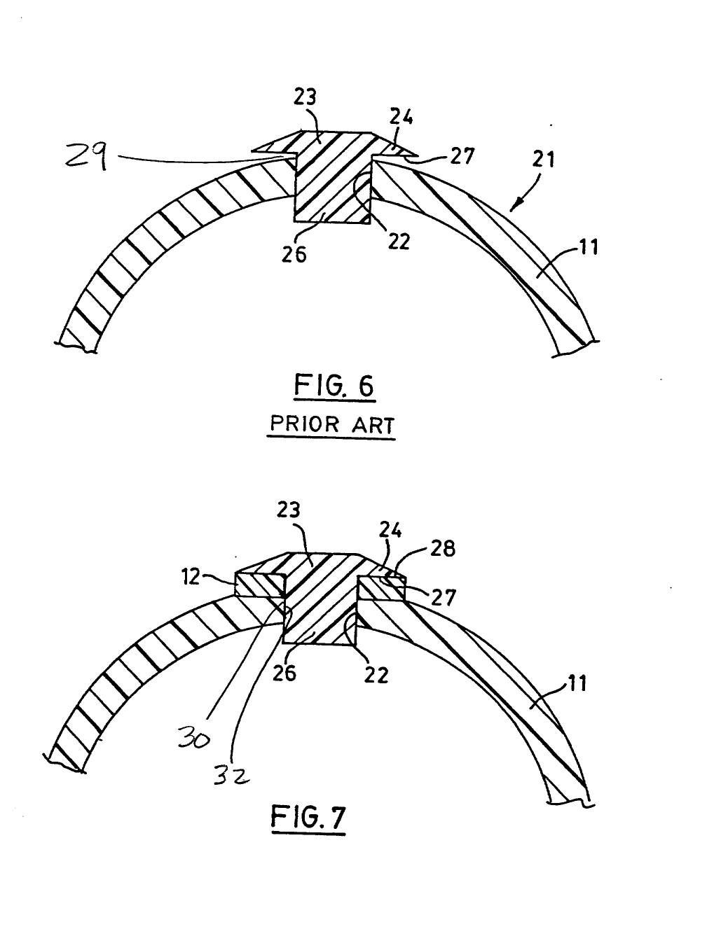

FIG. 6 shows a partially schematic transverse cross-section through a known form of casing and a mechanical plug closure.

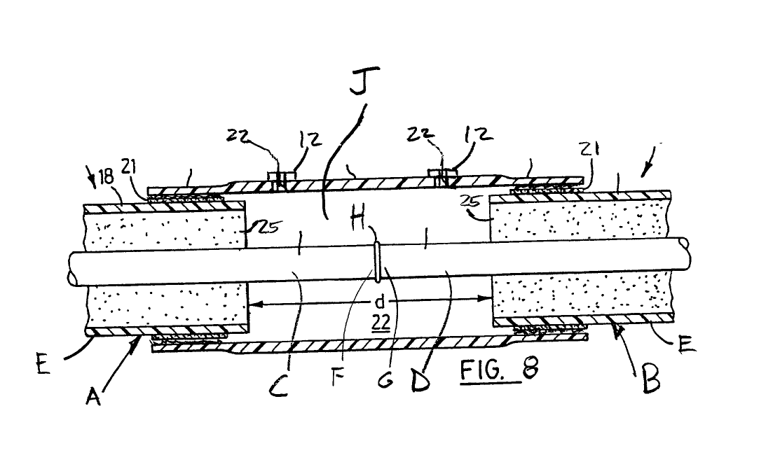

FIG. 7 shows a partially schematic transverse cross-section through a casing member in accordance with the invention having plug closure.

FIG. 8 shows a partially schematic longitudinal cross-section through a casing member applied over a joint between two adjacent sections of insulated pipe.

Referring to the drawings, wherein like reference numerals indicate like parts, FIGS. 1 and 1a show a casing 10 comprising a one piece circumferentially shrinkable crosslinked plastics material tubular sleeve 11 having at least one and usually two patches 12 bonded to it. The sleeve 11 includes a pair of ends 11a and 11b. The patches 12 are usually of plastics sheet material that preferably is uncrosslinked or is less crosslinked than the material of the sleeve 11. For example, the sleeve and patches may comprise a polyolefin, or a blend of a polyolefins. Usually the patches 12 are aligned axially and are spaced inwardly from the ends 11a, 11b of the sleeve 11. Preferably, the patches 12 have a generally rounded circumference and do not have corners that may tend to be lifted up if the sleeve is subjected to soil stress. More preferably the patches are circular since this may facilitate application to the sleeve and is more economical in usage of materials since the hole and plug (discussed below) are usually round.

The procedures for forming the sleeve 11 are in themselves well known to those skilled in the art. Reference may be made, for example, to the description in the above mentioned PCT publication WO 98/21517.

The procedures for bonding the patches 12 to the sleeve 11 may, for example, be generally similar to those used for providing a relatively uncrosslinked tubular inner member described in WO 98/21517, except discrete patches are employed and the patches 12 are bonded on an outside surface 15a of the sleeve 11. The patches 12 may be applied to the sleeve 11 before or after expansion. For example, the patches 12, if relatively uncrosslinked, may be fusion bonded or welded to the sleeve 11, or if crosslinked may be bonded to the sleeve 11 by a conventional adhesive agent, or the patches 12 may be initially bonded with a conventional adhesive agent and then are subsequently fused or welded to the sleeve 11. As will be apparent to those of ordinary skill in the art many different welding techniques may be used including application of elevated temperature and pressure, friction welding, spinning, induction welding, etc.

In one example of a procedure for making the casing, a heat shrinkable sleeve 11 may be heated to heat shrink it down onto a collapsible mandrel that is sufficiently large that the sleeve 11 will remain heat shrinkable after removal from the mandrel. The patches 12 are applied and the assembly is placed in an oven to fuse the patches 12 to the sleeve 11. The assembly is cooled, the mandrel collapsed, and the completed casing 10 removed from the mandrel.

FIG. 2 shows a further embodiment of a casing 13 wherein patches 12 are disposed on a recess 19 (i.e., a recessed portion of the surface of the sleeve 11 that is offset inwardly from the adjacent outer surface 15a of the sleeve 11) so that the surface of each patch 12 is generally flush with the adjacent outer surface 15a of the sleeve 11. This arrangement has the advantage that it reduces soil stress.

The casing 13 may, for example, be formed by applying the patches 12 on a crosslinked sleeve 11, and placing the assembly within a cylindrical mold comprising two or more sections, and heating the assembly while closing the ends of the sleeve 11 and passing steam or air into the interior of the sleeve 11 through ports in the sealing means, so that the sleeve 11 together with the patches 12 expands outwardly to conform to the inner side of the mold. The assembly is rapidly cooled and the mold sections are opened to allow removal of the finished casing 13 from the mold.

FIG. 3 shows a further form of casing 14 wherein, instead of two discrete patches 12 an elongated strip form patch 16 extending longitudinally axially of the sleeve 11. This provides an advantage of allowing some flexibility in the positioning of the hole or holes to be formed through the patch 16 in the event that the length of the exposed or bare end portions of the insulated pipe is somewhat variable.

The casing 14 as shown in FIG. 3 may, for example, be formed generally in the manner described above for the casing 10 with reference to FIGS. 1 and 1a except a strip form patch is bonded to the exterior of the sleeve 11 before heating and expansion.

FIGS. 4 and 4A show a further form of casing 17 wherein the patches 12 are bonded to an inner surface 15b of the sleeve 11. Such casing may be formed by, for example, clamping the patches 12 to the inner surface 15b of a crosslinked unexpanded sleeve 11, heating the assembly to bond the patches to the sleeve 11 and subsequently heating and expanding the sleeve 11 in the conventional manner.

FIGS. 5 and 5a show a still further form 18 wherein a strip form patch 16 is bonded to the inner surface 15b of the sleeve 11. This casing may, for example, be formed in a manner generally similar to that described with the casing 17 with reference to FIGS. 4 and 4a above, except a strip form patch 16 is bonded to the inner surface 15b of the sleeve 11 before expansion.

The casing 17 and 18 of FIGS. 4 and 5 have the advantage that they are subject to substantially less soil stress than the embodiments that have the patch or patches bonded on the outer side of the sleeve.

While the casings described in detail above with reference to the drawings generally comprise sleeves 11 that are heat shrinkable along the whole of their length, it is of course possible to provide casings in accordance with the invention comprising a patch or patches bonded to a sleeve that is heat shrinkable only at its end portions. Such sleeves and procedures for making them are well known to those skilled in the art and are described, for example, in U.K. patent application No. 284,804 dated Jul. 1, 1987, in the name Tjaerekopagniet Danske, to which reference may be made for details.

Referring to FIG. 8, in use, the casings 10 through 18 described above with reference to the drawings may be applied to forming an insulated joint between insulated sleeve 11 to provide a passageway communicating from the outside to the interior of the casing such as casing 10. Preferably, two holes are drilled so that the liquid precursor may be poured through one of them into the cavity J while the other hole functions as a vent.

Following the pouring of the liquid precursor into the cavity J, and after allowing the foam to form and cure, the drilled holes are closed with a plastic plug 23. In the case in which the patch 12 or 16 is weldable, that is, is uncrosslinked or is less crosslinked than the material of the sleeve 11, the plug may be heated to cause it to fuse or weld to the exposed margin of the patch 12 or 16 at the edges of the opening that is formed through the patch. Alternatively, a mechanically attached plug may be used to close the opening, as described in more detail below.

FIG. 6 shows a known form of casing 21 comprising a sleeve 11 having a foam hole 22 through it closed by the plug 23. The plug 23 includes an enlarged head 24 and a body 26 that engages mechanically within or locks within the hole 22 in known manner. This closure relies on intimate contact between the head 24 of the plug 23 and the surface of the sleeve 11. While this can usually be achieved with large diameter casings 21, for example greater than 160 mm in diameter, with smaller diameter casings for example less than 125 mm, for example 63 mm diameter, the radius of curvature of the sleeve 11 is too small to allow intimate contact so that there is a gap 29 between the underside 27 of the head 24 and the sleeve 21, as seen in FIG. 6.

In the present invention, there may be provided a patch 12 as seen in FIG. 7, the outer side 28 of which may be planar or at least provides a larger radius of curvature than the sleeve 11, as seen in FIG. 7, so that there is good contact between the patch 12 and the underside 27 of the head 24 of the plug 23.

Such a flattened patch 12 may be provided, for example by placing a rigid metal disc (not shown) of the same size and shape as the patch 12, over the patch 12 and then expanding the sleeve 11 and the patch 12 within an external mandrel. Alternatively, after expansion, the sleeve 11 with the patch 12 over it may be placed in a small press with a heater that heats and fuses the patch 12 to the sleeve 11 and fuses the outer side 28 of the patch 12 flat. The stiffness and thickness of the patch 12, when fused to the sleeve 11, help flatten out the curvature of the section comprising the patch 12. It will be appreciated that the flattened patch may be a strip form patch 16.

As shown in FIG. 7, a further advantage of the patch 12 or 16 is that it provides a thickened section 30 in the wall of the sleeve 11 at the point where the closure plug such as plug 23 is to be applied. As such, a generally cylindrical interface 32 is formed between the body 26 of the plug 23 and the surrounding thickened section 30. It will be noted that the interface 32 will have a greater surface area than would be offered by a hole (not shown) solely through the wall of the sleeve 11.

The wall thickness of casings used with small diameter pipeline may be 1.0 to 3.0 mm, often 1.5 to 2.5 mm, and such wall thickness may provide insufficient surface area to obtain adequate welding of the plug to the side wall of the opening formed through the sleeve. The inadequate welding increases the risk of the plug becoming dislodged or damaged when the pipeline is subjected to dynamic soil stress. The provision of the patch 12 or 16 on thin-walled casings alleviates the problem of inadequate weld area by virtue of the fact that the interface 32 in the thickened the section 30 offers the increased surface area.

Further, where a mechanically attached plug, such as plug 23, is used, a sleeve wall thickness of 1.0 to 3.0 mm may be insufficient to achieve secure locking of the plug 23 to the sleeve. However with the provision of a discrete or puck-like patch 12 or strip form patch 16, sufficient wall thickness can be obtained to achieve a secure locking of the plug 23 to the sleeve 11.

Presently, it is contemplated that usually the said opening or openings will be formed through the patch member and sleeve wall in the field, in the course of installation of the casing 10. In a modification, however, the hole or holes 22 may be formed through the patch 12,16 in the factory.

Preferably, each patch 12 or patch strip 16 is about 15 mm to about 120 mm wide (viewing FIG. 7), more preferably about 30 mm to about 60 mm wide and may be about 5 mm wider on each side than the plug. Typically, the plugs are about 20 mm to 50 mm in diameter, most commonly about 35 mm in diameter.

Whereas it is known to use patches that are applied over an edge of a wrap around sleeve at an overlap with a view to connecting the overlap edge to the underlying portion of the sleeve, and to use patches over tears or holes in sleeves, in the present invention the patch or patches are not applied over an edge or over a hole in the sleeve, but are applied over a region spaced inwardly from an edge so that the sleeve extends beyond the patch on all sides and hence are applied over a continuous imperforate or intact portion of the sleeve surface. Further, whereas such known patches are maintained imperforate, in the present invention when the casing is modified to provide an opening through it, the opening is formed through the patch, as well as through the adjacent portion of the casing, these openings being in registry with one another.

While the above detailed description with reference to the drawings has referred to tubular extruded heat shrinkable sleeves, it will be appreciated that the patch or patches 12 or 16 may be employed on a heat shrinkable wrap around sleeve. For example, they may be bonded to a continuous imperforate or intact portion of the surface of a conventional wrap around sleeve comprising a sheet that is at least partially heat shrinkable along a heat shrink direction and that is, or of which sections are, adapted to be formed into a tubular sleeve by connecting an edge of the sheet to a portion spaced therefrom in the heat shrink direction. Such sleeves are in themselves well known and are described, for example, in U.S. Pat. Nos. 4,472,468 (Tailor et al), 5,175,032 (Steele et al) and 5,411,777 (Steele et al) and need not be described in detail herein.

Some examples providing further details are given below.

### EXAMPLE 1

A high density polyethylene tube was extruded with a wall thickness of 2.0 mm and an inside diameter of 119 mm. It was crosslinked by electron beam radiation to obtain a gel fraction (degree of crosslink) of 50%. Patches were die cut from a high density polyethylene 2.0 mm thick sheet into a round shape of 45 mm diameter.

The high density polyethylene (HDPE) used for the tube and for the patches was NOVACOR® HEY449A from Nova Chemicals.

The extruded tube was cut to a 750 mm length, and the patches were placed centrally 330 mm apart, and secured down with 50 mm wide high temperature tape.

The tube was placed in the oven at 140° C. for 30 minutes, and then placed in an expander. Air was blown inside the tube which expanded against an external metal mandrel, which is cooled. After 3 minutes of cooling, the part was removed. The resulting expanded casing had two patches secured and bonded to them as shown in FIGS. 2 and 2A.

The 35 mm wide holes were drilled in the patches and through the underlying portion of the tube wall to form through holes and HDPE plugs from ABB I.C. Moller were welded into the holes successfully.

### EXAMPLE 2

The procedure of Example 1 was repeated, except the sheet from which the patch was cut, was laminated with an adhesive as follows:

1.5 mm thickness, HDPE as in Example 1.

0.5 mm thickness: Laminated adhesive type FUSABOND® 482 from DuPont.

45 mm. diameter patches were die cut from this sheet and applied to the casing followed by welding of the plugs as described in Example 1.

### EXAMPLE 3

The same tube and patch material described in Example 1 were used. The patch was cut into a 45 mm×350 mm strip. The strip was centrally positioned inside the tube and clamped between two metal bars. This assembly was placed in the oven at 160° C. for 30 minutes to allow the fusion of the patch to the casing tube to take place.

The tube was removed from the oven and expanded. The finished tube had a strip patch inside as shown in FIGS. 5 and 5A.

### EXAMPLE 4

The procedure of Example 1 was followed, with the following changes. After the round 45 mm diameter patches were placed on the casing, a steel disc, 2 mm thick×45 mm diameter was placed over each patch, and secured with a high temperature tape. The assembly was then expanded as described in Example 1. Where the steel disks made contact with the curvature of the external mandrel, the patches remained flat, thus imparting flatness to the patch, while the rest of the casing conformed to the curvature of the mandrel. After cooling, the part was removed, the discs were taken off, and a casing with two flat patches was obtained.

1. A casing member for forming a connection between first and second tubular pipe sections, the casing member comprising:
a tubular sleeve having a first end, a second end, and a continuous central section extending between the first and second ends;
the first end sized to fit over an end portion of the first tubular pipe section;
the second end sized to fit over an end portion of the second tubular pipe section, each of the first and second ends being heat-shrinkable; and
a patch bonded to a surface of the central section.

2. The casing member of claim 1, wherein the tubular sleeve is comprised of a crosslinked plastic material and wherein the patch is comprised of a plastic material that is less crosslinked than the tubular sleeve.

3. The casing member of claim 1, wherein the tubular sleeve is comprised of a crosslinked plastic material and wherein the patch is comprised of an uncrosslinked plastic material.

4. The casing member of claim 1, wherein the patch is non-rectilinear.

5. The casing member of claim 1, wherein the sleeve includes a longitudinal axis, and wherein the patch comprises a strip oriented parallel to the longitudinal axis.

6. The casing member of claim 1, wherein the surface of the tubular sleeve comprises a generally cylindrical outer surface, and wherein the outer surface includes at least one recess, and wherein the parch is bonded to the recess.

7. The casing member of claim 1, wherein the surface of the tubular sleeve comprises a generally cylindrical inner surface.

8. The casing member of claim 1, wherein the surface of the tubular sleeve comprises a generally cylindrical outer surface having a first radius of curvature, and wherein the patch includes an outer surface having a second radius of curvature larger than the first radius of curvature.

9. The casing member of claim 1, wherein the surface of the tubular sleeve comprises a generally cylindrical outer surface having a first radius of curvature, and wherein the patch includes a generally flat outer surface.

10. A casing member for forming a connection between first and second tubular pipe sections, the casing member comprising:
a one piece tubular sleeve having a first end, a second end, and a central section extending between the first and second ends, the tubular sleeve formed of a crosslinked plastic material;
the first end sized to receive therein an end portion of the first tubular pipe section;
the second end sized to receive therein an end portion of the second tubular pipe section, each of the first and second ends of the tubular sleeve being heat-shrinkable;
at least one patch bonded to a receiving portion of the central section and spaced away from either of the first and second ends, the at least one patch formed of a plastic material that is less crosslinked than the tubular sleeve; and
a hole extending through the patch and the portion of the central section.

11. The casing member of claim 10, wherein the surface portion of the central section comprises a generally circular recess formed in an outer surface of the tubular sleeve, and wherein the patch is generally circular and sized to be received in the recess.

12. The casing member of claim 10, wherein the surface portion of the tubular sleeve comprises a curved outer surface of the tubular sleeve, and wherein the patch includes an outer surface that is less curved than the outer surface of the sleeve.

13. The casing member of claim 10, in combination with a plug having widened head and a body, the body being sized to be received in the hole, and means for securing the plug to the tubular sleeve.

14. The casing member of claim 10, wherein the sleeve includes a sidewall having a first thickness, and wherein the patch and the receiving portion of the tubular sleeve cooperate to form a second thickness, the second thickness greater than the first thickness, and including a plug secured to the casing member, the plug having a body disposed in the hole and a widened head arranged to abut an outer surface of the patch.

15. The casing member of claim 10, wherein the sleeve includes a sidewall having a first thickness, and wherein the patch and the receiving portion of the tubular sleeve cooperate to form an interface having a second thickness, the second thickness greater than the first thickness, and including a plug secured to the casing member, the plug having a body disposed in the hole and a widened head arranged to abut an outer surface of the patch.

16. The casing member of claim 15, wherein the plug is bonded to the casing member along at least one of the interface and the outer surface of the patch.

17. The casing member of claim 15, wherein the body of the plug is mechanically secured in the hole.

18. A method of sealing and insulating a weld joint between two lengths of insulated pipe, each pipe having an uninsulated end portion adjacent the weld joint, the method comprising the steps of:
applying a casing member over the weld joint, the casing member having a pair of ends, an interconnecting tubular sleeve, and a patch secured to the tubular sleeve;
positioning the casing member so that each of the ends overlaps an adjacent portion of the pipe insulation;
bonding each of the ends to the adjacent portion of the pipe insulation;
providing a hole through the patch and the tubular sleeve;
providing a foam composition within the tubular sleeve; and
closing the hole with a plug.

19. The method of claim 18, wherein the step of providing the foam composition within the tubular sleeve includes the steps of:
introducing a liquid precursor of the foam composition through the hole; and
allowing the liquid precursor to foam and cure.

20. The method of claim 19, including the steps of:
providing a second patch and a second hole through the second patch;
allowing air to escape through the second hole during the introducing and curing steps of the liquid precursor; and
closing the second hole with a second plug.

21. The method of claim 18, wherein the casing member is comprised of a plastic material that is at least partially crosslinked, and wherein the patch is comprised of a plastic material that is less crosslinked than the casing member, and including the step of fusion bonding the plug to a generally cylindrical edge portion of the hole.

22. The method of claim 18, wherein each of the ends is bonded to the adjacent end portion of the insulated pipes by heat shrinking.

23. The method of claim 18, wherein the patch is secured to the tubular sleeve by at least one of fusion bonding or welding.
